(19) United States
(12) Patent Application Publication
(10) Pub. No.: US 2007/0086059 A1
(43) Pub. Date: Apr. 19, 2007

(54) IMAGE SHARPNESS DEVICE AND METHOD

(75) Inventors: Ming-Jong Jou, Tainan City (TW); Yao-Jen Hsieh, Taichung City (TW); Huan-Hsin Li, Miaoli County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORP., Hsinchu 300 (TW)

(21) Appl. No.: 11/421,495

(22) Filed: Jun. 1, 2006

(30) Foreign Application Priority Data
Oct. 18, 2005 (TW) 94136323

(51) Int. Cl. H04N 1/409

(52) U.S. Cl. 358/3.27; 358/532

(57) ABSTRACT

An image sharpness method is provided. The image sharpness method includes the steps of determining a plurality of sharpness gray level increments for a current pixel in accordance with a non-linear visual function and gray level differences between the current pixel and the neighboring pixels of the current pixel, using the sum of the sharpness gray level increments as a total sharpness gray level increment, and using the sum of the total sharpness gray level increment and the gray level of the current pixel as a sharpness gray level of the current pixel.

### BACKGROUND OF THE INVENTION

1. Field of the Invention

The invention relates to image sharpness, and more specifically to an image sharpness method used in an image comprising characters and patterns.

2. Description of the Related Art

Conventional image sharpness methods amplify gray level differences between neighboring pixels, enhancing the amplitude of pixel edges. Thus, the image becomes more distinct, improving recognition degree.

FIG. 1 is a schematic diagram of a 1D (one-dimensional) image, wherein X(i) represents the gray level of the i^{st} pixel. In conventional image sharpness methods, a gray level increment ΔL is obtained according to the gray level difference |X(i+1)−X(i)| between the i^{st} and (i+1)^{st} pixels and a linear visual function shown in FIG. 2 and the gray level increment ΔL is subtracted from the gray level of the i^{st} pixel, X(i), to obtain a new gray level of the i^{st} pixel (i.e. X(i)′=(X(i)−ΔL)). For the (i+1)^{st} pixel, its original gray level X(i+1) plus the gray level increment ΔL is a new gray level of the (i+1)^{st} pixel (i.e. X(i+1)′=(X(i+1)+ΔL)). An image having new gray levels of pixels after sharpness processing is thus obtained. FIG. 3 shows the gray levels of the i^{st} and (i+1)^{st} pixels after sharpness processing. As shown in FIG. 3, the gray level difference between the two neighboring pixels increases from |X(i+1)−X(i)| to |X(i+1)−X(i)|+|2ΔL|, thus the image becomes more distinct due to greater gray level difference.

However, when using the conventional image sharpness method in a character image, overshoot occurs at the edges of text, causing ring effect, a white ring occurring at the edges of black text. Thus, an image sharpness method used in an image comprising characters and patterns is desired, avoiding ring effect and maintaining performance of image sharpness.

### BRIEF SUMMARY OF THE INVENTION

A detailed description is given in the following embodiments with reference to the accompanying drawings.

The invention is generally directed to an image sharpness method. An exemplary embodiment of an image sharpness method comprises determining a plurality of sharpness gray level increments for a current pixel in accordance with a non-linear visual function and gray level differences between the current pixel and the neighboring pixels of the current pixel, using the sum of the sharpness gray level increments as a total sharpness gray level increment, and using the sum of the total sharpness gray level increment and the gray level of the current pixel as a sharpness gray level of the current pixel.

Another image sharpness method is provided. The image sharpness method comprises the steps of determining a plurality of sharpness gray level increments for a current pixel in accordance with a non-linear visual function and gray level differences between the current pixel and the neighboring pixels of the current pixel, wherein when a gray level difference between a first pixel and a second pixel is less than a reference value, a predetermined increment is used as the sharpness gray level increments corresponding to the gray level differences between the current pixel and the first pixel and that between the current pixel and the second pixel, wherein the first and second pixels neighbor the current pixel and the current pixel is between the first and second pixels, using the sum of the sharpness gray level increments as a total sharpness gray level increment, determining whether an image unit including the current pixel is a horizontal texture block in accordance with the gray level differences between each horizontal neighboring pixel of the image unit, changing a value of a horizontal texture variable in accordance with the result of whether the image unit is the horizontal texture block and adjusting the total sharpness gray level increment in accordance with the horizontal texture variable and a horizontal texture threshold, and using the sum of the total sharpness gray level increment and the gray level of the current pixel as a sharpness gray level of the current pixel.

An image sharpness device is provided. The image sharpness device comprises a pixel gray level comparator and a sharpness processor. The pixel gray level comparator receives image data and compares the gray level of a current pixel of the image data to that of the neighboring pixels of the current pixel to generate a plurality of gray level difference values. The sharpness processor, coupled to the pixel gray level comparator, determines a plurality of sharpness gray level increments in accordance with each gray level difference and a non-linear visual function. The sharpness processor uses the sum of the sharpness gray level increments as a total sharpness gray level increment and uses the sum of the total sharpness gray level increment and the gray level of the current pixel as a sharpness gray level of the current pixel.

### BRIEF DESCRIPTION OF THE DRAWINGS

The invention can be more fully understood by reading the subsequent detailed description and examples with references made to the accompanying drawings, wherein:

FIG. 1 is a schematic diagram of pixels of a 1D image.

FIG. 2 is a schematic diagram of a linear visual function.

FIG. 3 is a schematic diagram of gray levels of the i^{st} and (i+1)^{st} pixels after sharpness processing.

FIG. 4 is a schematic diagram of a 3×3 pixels image unit.

FIG. 5 is a flowchart of an image sharpness method according to an embodiment of the invention.

FIG. 6 is a schematic diagram of a non-linear visual function.

FIG. 7 is a schematic diagram of sharpness gray level increments corresponding to the neighboring pixels of the image unit of FIG. 4.

FIGS. 8A and 8B are schematic diagrams illustrating gray levels of three neighboring pixels with and without spike noise respectively.

FIG. 9 is a schematic diagram of pixels used in comparison when eliminating spike noise.

FIG. 10 is a schematic diagram of horizontal neighboring pixels used in comparison when detecting horizontal texture.

FIG. 11 is a schematic diagram of an image including the image unit of FIG. 4.

FIG. 12 is a schematic diagram of vertical neighboring pixels used in comparison when detecting vertical texture.

FIG. 13 is a schematic diagram of an image sharpness device according to an embodiment of the invention.

FIG. 14 is a schematic diagram of an exemplary sharpness processor of FIG. 13.

FIG. 15 is a schematic diagram of an exemplary horizontal texture detector of FIG. 14.

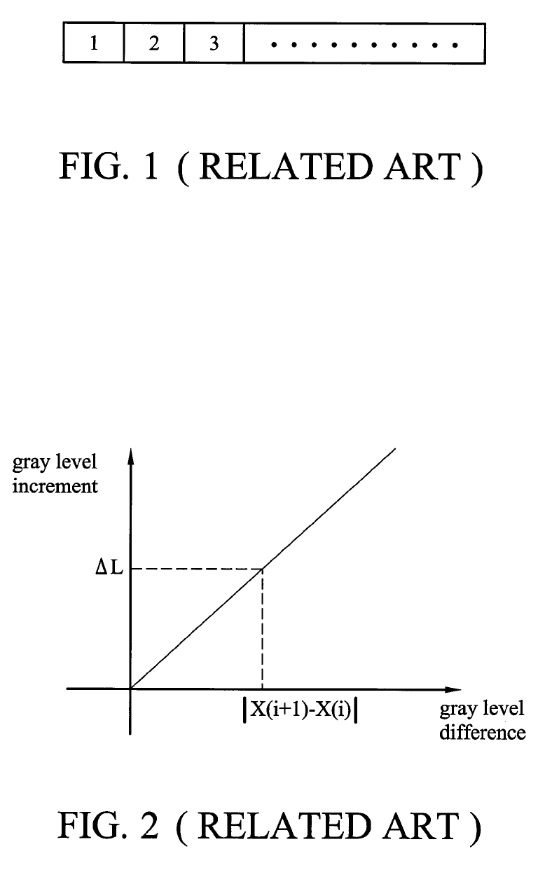

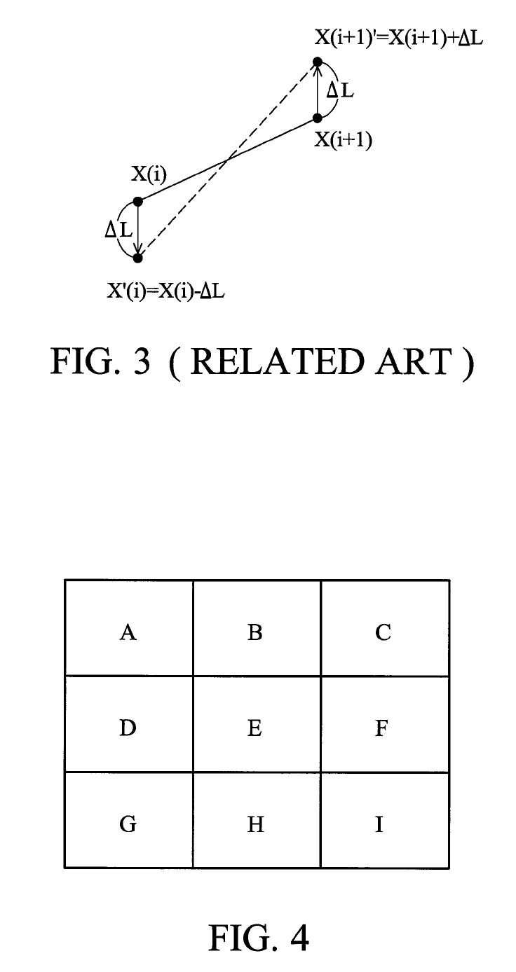

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

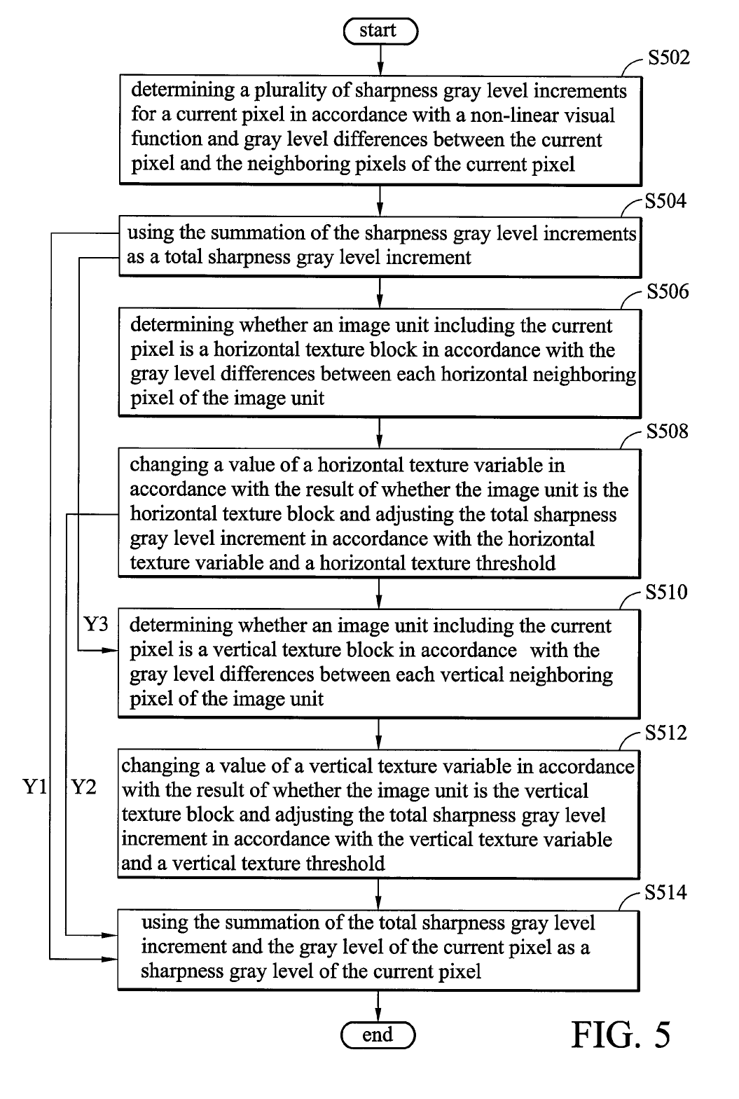

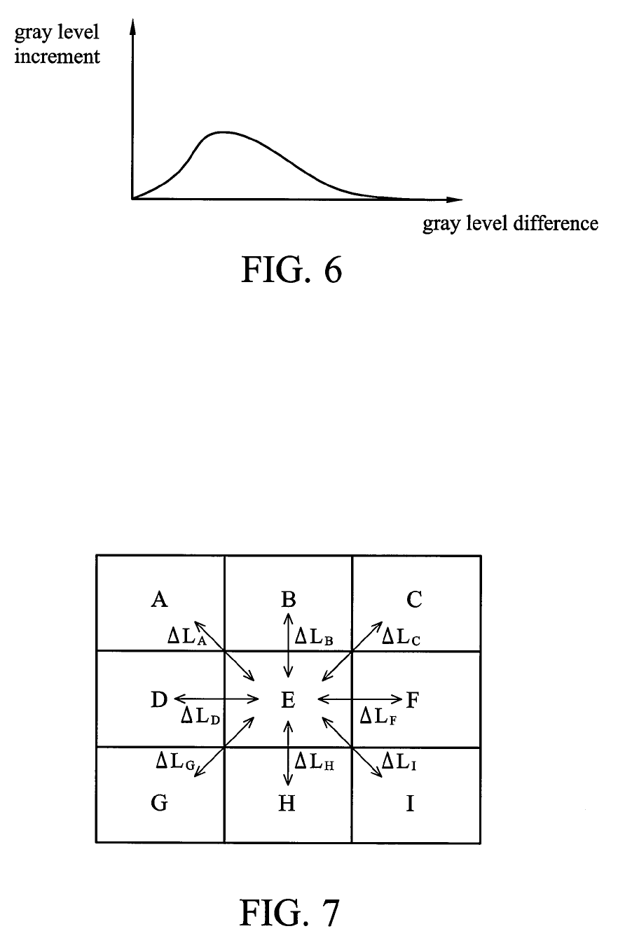

FIG. 4 shows a 3×3 pixel image unit 40 of which labels A˜I represent pixels respectively. FIG. 5 is a flowchart of an image sharpness method 500 according to an embodiment of the invention. In step S502, a plurality of sharpness gray level increments for a current pixel is determined in accordance with a non-linear visual function shown in FIG. 6 and gray level differences between the current pixel and the neighboring pixels of the current pixel. Proceeding to step S504, the sum of the sharpness gray level increments is used as a total sharpness gray level increment and the sum of the total sharpness gray level increment and the gray level of the current pixel is used as a sharpness gray level of the current pixel in step S514 (following arrow Y1). It is assumed that the current pixel is the pixel E of the image unit 40 and its original gray level is X_{E}. In step S502, sharpness gray level increments ΔL_{A}˜ΔL_{D} and ΔL_{F}˜ΔL_{I} shown in FIG. 7, corresponding to neighboring pixels A˜D and F˜I respectively, are obtained according to a non-linear visual function shown in FIG. 6 and gray level differences |X_{E}−X_{A}|˜|X_{E}−X_{D}| and |X_{E}−X_{F}|˜|X_{E}−X_{I}| of the neighboring pixels of pixel E, pixels A˜D and F˜I respectively. The non-linear visual function shown in FIG. 6 is obtained from statistics of gray level distributions of natural images and character images. For example, for the current pixel E and its neighboring pixel A, a gray level difference |X_{E}−X_{A}| therebetween is obtained. With the non-linear visual function shown in FIG. 6 and the gray level difference |X_{E}−X_{A}|, a sharpness gray level increment ΔL_{A} with respect to pixel A can be obtained. Similarly, sharpness gray level increments ΔL_{B}˜ΔL_{D} and ΔL_{F}˜ΔL_{I} with respect to pixels B˜D and F˜I respectively can also be obtained.

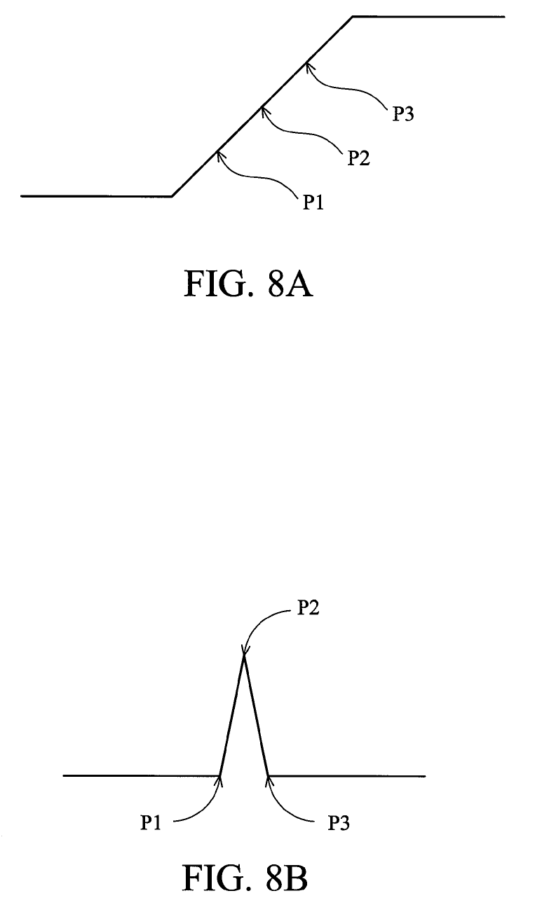

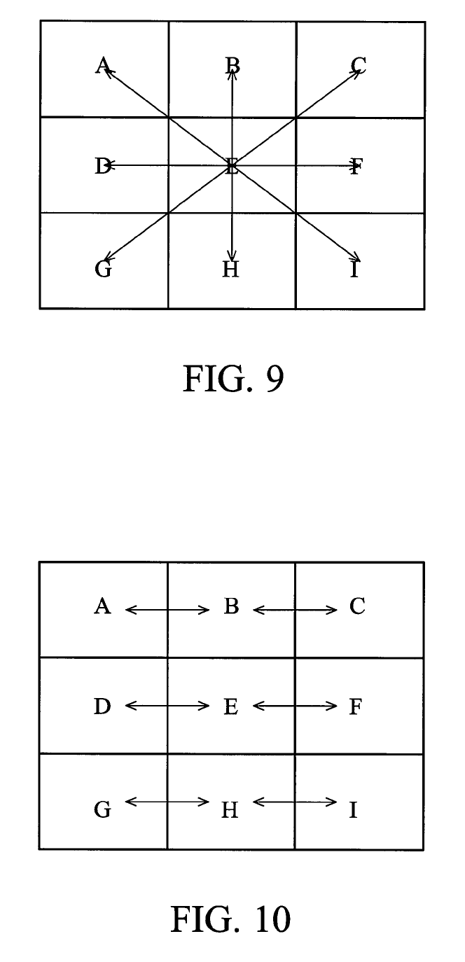

However, spike noise must be considered in image sharpness processing. FIGS. 8A and 8B are schematic diagrams of gray levels of three neighboring pixels P1˜P3 with spike noise and without spike noise respectively. As shown in FIG. 8A, pixel P2 shows spike noise when the gray level difference between the two neighboring pixels P1 and P3 of pixel P2, |X_{P1}−X_{P3}|, is less than a reference value. Conversely, as shown in FIG. 8B, there is no spike noise when the gray level difference between the two neighboring pixels P1 and P3 of pixel P2, |X_{P1}−X_{P3}|, exceeds a reference value. When spike noise as shown in FIG. 8A occurs, the sharpness degree of pixel P2 with respect to pixels P1 and P3 need not be enhanced in the image sharpness processing. Thus, in an embodiment of the invention, in step S502, when the gray level differences between neighboring pixels of the current pixel at the left and right, top and bottom and corners respectively are less than a reference value, a predetermined increment ΔL_{fixed} is used as their corresponding gray level increments. More specifically, as shown in FIG. 9, when dealing with pixel E, gray level differences between its neighboring pixels D and F at right and left sides, B and H at top and bottom sides, G and C and A and I on diagonal lines are considered. For the neighboring pixels of pixel E at right and left sides, D and F, when |X_{D}−X_{F}|<ΔL_{fixed}, the sharpness gray level increments ΔL_{D} and ΔL_{F} corresponding to pixels D and F respectively are ΔL_{fixed}. In one embodiment, the predetermined increment ΔL_{fixed} is 0.

In step S504, the gray level increments ΔL_{B}˜ΔL_{D} and ΔL_{F}˜ΔL_{I} are summed to obtain a total gray level increment ΔLₜₒₜₐₗ_{_{—}}_{E} of pixel E. The method 500 may turn to step S514 (arrow Y1) directly. In this case, a sharpness gray level of pixel E, X_{E}′, is obtained from the sum of the total gray level increment ΔLₜₒₜₐₗ_{_{—}}_{E} and its original gray level X_{E}, that is X_{E}′=X_{E}+ΔLₜₒₜₐₗ_{_{—}}_{E}. In other embodiments, the method 500 may proceed to steps S506˜S512 to further detect image texture.

If there is continuous color level variation in the original image, discontinuous speckles may occur in the image after sharpness processing. Thus, in an embodiment, the method 500 may proceed to step S506 after step S504 for image texture detection. In step S506, whether an image unit including the current pixel is a horizontal texture block is determined in accordance with the gray level differences between each horizontal neighboring pixel of the image unit. Using the image unit 40 shown in FIG. 4 as an example, when the current pixel is pixel E, the image unit is the 3×3 pixel image unit shown in FIG. 4, comprising pixels A˜I. In step S506, the gray level differences of the horizontal neighboring pixels of the image unit are obtained. As shown in FIG. 10, the gray level differences between pixels A and B, B and C, D and E, E and F, G and H and H and I are calculated respectively, and whether the image unit is a horizontal texture block is determined in accordance with the calculated gray level differences. In an embodiment, the step of determination comprises the steps of comparing each gray level difference of the horizontal neighboring pixels to a horizontal gray level difference reference value ΔX_{hori.} and changing a value of a horizontal block variable h_priority according to the comparison result. After comparing all the horizontal neighboring pixels of the image unit, if the horizontal block variable h_priority exceeds a horizontal block reference value n_{—}_{^{hori}}, the image unit is a horizontal texture block. Using pixels A and B of the image unit 40 as an example, when |X_{A}−X_{B}|<ΔX_{hori.}, the value of the variable h_priority increases with 1, and similar processing for pixels B and C, D and E, E and F, G and H and H and I is implemented. If the horizontal block reference value n_{—}_{^{hori}} is 3 and the final value of the variable h_priority is 5, the image unit 40 is a horizontal texture block.

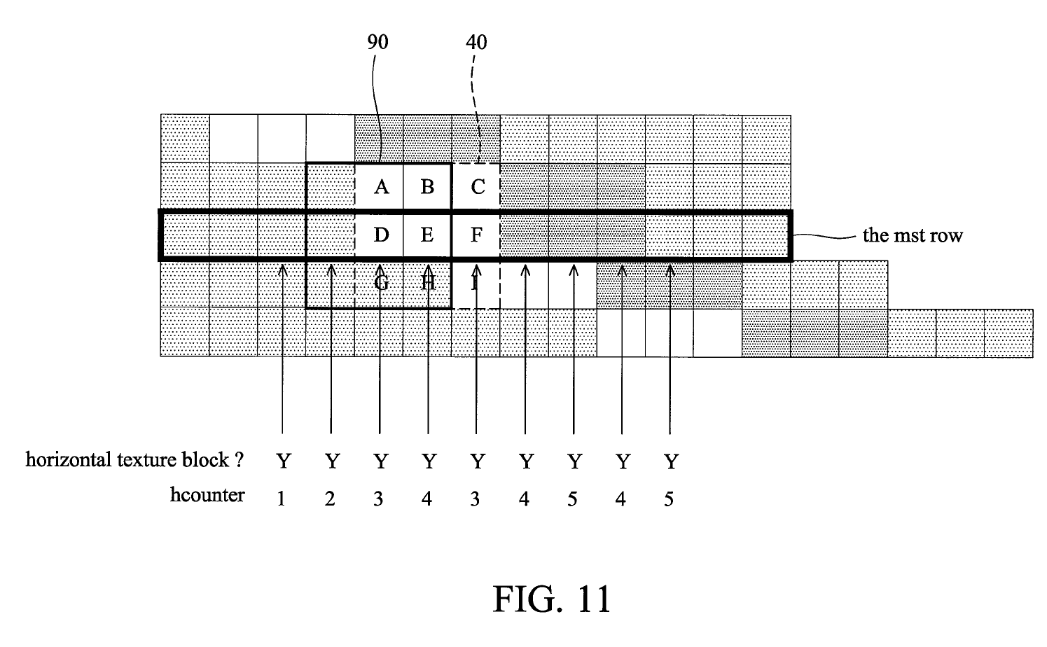

FIG. 11 shows an image including image unit 40. When determining the total gray level increment ΔLₜₒₜₐₗ_{_{—}}_{E} in image sharpness processing, the horizontal texture of pixels in the same row of the image are considered for horizontal texture determination of step S506. Thus, after determining if an image unit is a horizontal texture block in step S506, in step S508, a value of a horizontal texture variable hcounter is changed in accordance with the result of whether the image unit is the horizontal texture block and the total sharpness gray level increment ΔLₜₒₜₐₗ is adjusted in accordance with the horizontal texture variable hcounter and a horizontal texture threshold n. If the image shown in FIG. 10 is 1024×768 pixels, when determining the total sharpness gray level increment ΔLₜₒₜₐₗ of pixel E, the 1023 pixels in the m^{st} row as the pixel E need to be considered in determining horizontal texture. As stated, When an image unit 40 of pixel E is a horizontal texture block, the value of the variable hcounter increases with 1, wherein horizontal texture variable hcounter relates to the pixels in the m^{st} row as the pixel E. As shown in FIG. 10, since the horizontal texture variable hcounter is 3 when dealing with the pixel D in the image unit 90, and the image unit 40 including pixel E is a horizontal texture block, the horizontal texture variable hcounter=3+1=4. The horizontal texture variable hcounter<the horizontal texture threshold n because the horizontal texture threshold n is 1024 since the image shown in FIG. 10 is a 1024×768 pixels image. Moreover, if the image unit is determined not to be a horizontal texture block in step S506, the horizontal texture variable hcounter is decreased by 1. The total sharpness gray level increment ΔLₜₒₜₐₗ of pixel E is adjusted in accordance with the horizontal texture variable hcounter and the horizontal texture threshold n. In an embodiment, the adjusted total sharpness gray level increment ΔLₜₒₜₐₗ of pixel E is ΔLₜₒₜₐₗ_{_{—}}_{E}′=ΔLₜₒₜₐₗ_{_{—}}_{E}*(n−hcounter)/n.

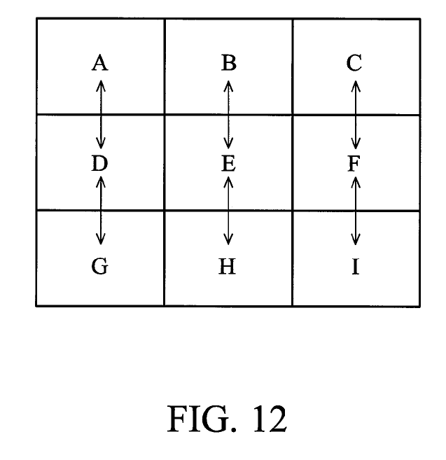

In an embodiment, the vertical texture of an image unit can be detected. In step S510, whether an image unit including the current pixel is a vertical texture block is determined in accordance with the gray level differences between each vertical neighboring pixel of the image unit. FIG. 12 shows the vertical neighboring pixels used in comparison when detecting the vertical texture of the image unit 40. In step S510, the gray level differences between each vertical neighboring pixel of the image unit are compared to a vertical gray level difference reference value and a value of a vertical block variable is changed according to the comparison result wherein if the vertical 1 block variable exceeds a vertical block reference value, the image unit is the vertical texture block. Those skilled in the art can proceed with this step in accordance with the method disclosed in step S506.

Proceeding to step S512, after determining whether an image unit is a vertical texture block, a value of a vertical texture variable is changed in accordance with the result of whether the image unit is the vertical texture block and the total sharpness gray level increment is adjusted in accordance with the vertical texture variable and a vertical texture threshold. The method of step S512 is similar to those disclosed in step S508 and is thus not further described.

It is noted that as stated, step S514 may follow steps S502 and S504 to output the image after sharpness processing according to design necessity (as arrow Y1 shown in FIG. 5), detect vertical or horizontal texture after step S504 as arrows Y2 and Y3 shown in FIG. 5, or detect both the vertical and horizontal textures in steps S506˜S512 after step S504 and output the image after sharpness processing in step S514. Those skilled in the art may adjust the flow of the embodiment according to the principle disclosed.

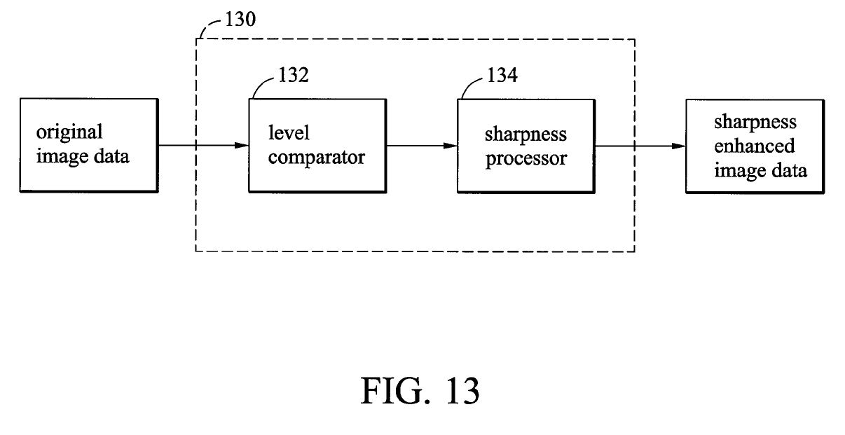

FIG. 13 is a schematic diagram of an image sharpness device 130 according to an embodiment of the invention. The image sharpness device 130 comprises a pixel gray level comparator 132 and a sharpness processor 134. The pixel gray level comparator 132 receives an original image data and compares the gray level of a current pixel of the image data to that of the neighboring pixels of the current pixel to generate a plurality of gray level differences. The sharpness processor 134, coupled to the pixel gray level comparator 132, determines a plurality of sharpness gray level increments in accordance with each gray level difference and a non-linear visual function. The sharpness processor 134 uses the sum of the sharpness gray level increments as a total sharpness gray level increment and uses the sum of the total sharpness gray level increment and the gray level of the current pixel as a sharpness gray level of the current pixel.

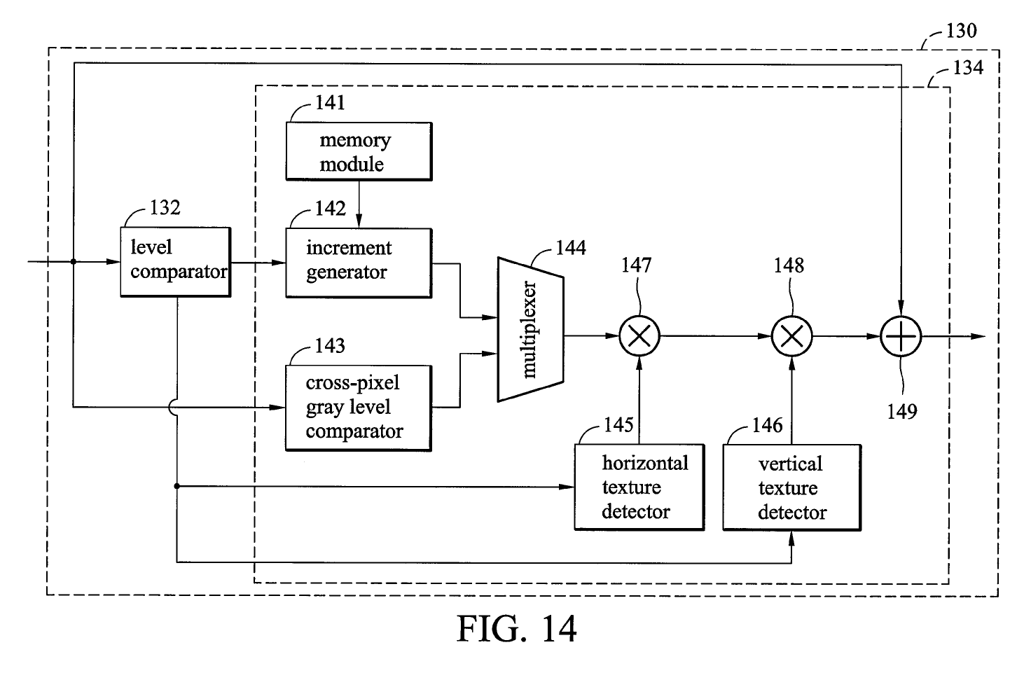

FIG. 14 shows an exemplary sharpness processor 134 of FIG. 13. The sharpness processor 134 comprises a memory module 141, an increment generator 142, a cross-pixel gray level comparator 143, a multiplexer 144, a horizontal texture detector 145, a vertical texture detector 146, two multipliers 147 and 148 and an adder 149. The memory module 141 stores a non-linear visual function. When the sharpness processor 134 receives a plurality of gray level differences from the pixel gray level comparator 132, the increment generator 142 obtains a corresponding gray level increment according to the non-linear visual function stored in the memory module 141 and the received gray level differences. As stated, to reduce disturbances caused by spike noise, the cross-pixel gray level comparator 143 receives the original image data, and uses the current pixel as a center to obtain gray level differences between horizontal neighboring pixels, vertical neighboring pixels and diagonal neighboring pixels. Each cross pixel gray level difference is compared with a reference value. When the cross pixel gray level difference is less than the reference value, the cross-pixel gray level comparator 143 outputs 0 and 1 when the cross pixel gray level difference exceeds the reference value. The multiplexer 144 receives the sharpness gray level increments from the increment generator 142 and the comparison result of the cross pixel gray level difference and the reference value from the cross-pixel gray level comparator 143. When the cross-pixel gray level comparator 143 outputs 1, the multiplexer 144 outputs the corresponding gray level increment and outputs a predetermined increment as the corresponding gray level increment when the cross-pixel gray level comparator 143 outputs 0. In an embodiment, the predetermined increment is 0. The gray level increments are summed to be output as a total gray level increment.

In an embodiment, a horizontal texture detecting mechanism may be involved. The pixel gray level comparator 132 compares the gray level of each horizontal neighboring pixel of an image unit including the current pixel. The horizontal texture detector 145 determines whether the image unit including the current pixel is a horizontal texture block according to gray level comparison result of the horizontal neighboring pixels in the image unit received from the pixel gray level comparator 132. More specifically, the horizontal texture detector 145 compares the gray level differences between each horizontal neighboring pixel of the image unit to a horizontal gray level difference reference value and changes a value of a horizontal block variable according to the comparison result. If the horizontal block variable exceeds a horizontal block reference value, the image unit is the horizontal texture block. The horizontal texture detector 145 then changes a value of a horizontal texture variable in accordance with the result of whether the image unit is the horizontal texture block and outputs the horizontal texture variable and a horizontal texture threshold to the multiplier 147 to adjust the total sharpness gray level increment output from the multiplexer 144.

Similarly, a vertical texture detecting mechanism may be involved. The pixel gray level comparator 132 compares the gray level of each vertical neighboring pixel of an image unit including the current pixel. The vertical texture detector 146 determines whether the image unit including the current pixel is a vertical texture block according to the gray level difference of the vertical neighboring pixels in the image unit, received from the pixel gray level comparator 132. More specifically, the vertical texture detector 146 compares the gray level differences between each vertical neighboring pixel of the image unit to a vertical gray level difference reference value and changes a value of a vertical block variable according to the comparison result. If the vertical block variable exceeds a vertical block reference value, the image unit is the vertical texture block. The vertical texture detector 146 then changes a value of a vertical texture variable in accordance with the result of whether the image unit is the vertical texture block and output the vertical texture variable and a vertical texture threshold to the multiplier 148 to adjust the total sharpness gray level increment.

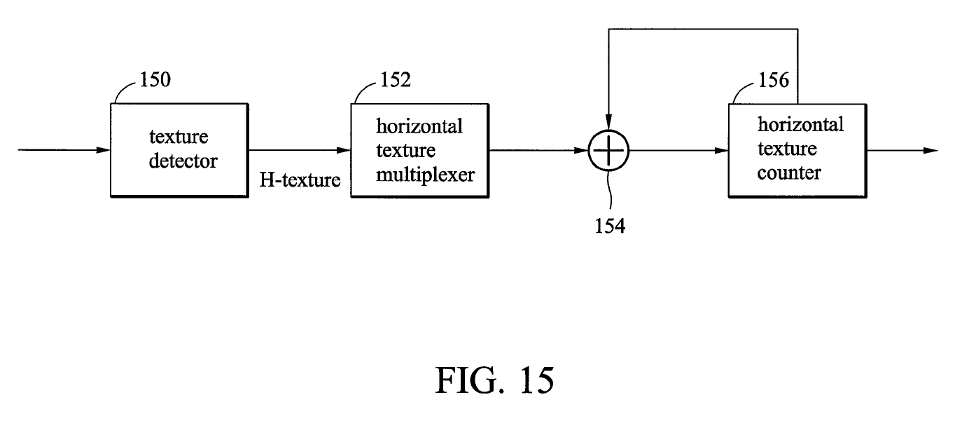

FIG. 15 shows an exemplary horizontal texture detector 145. The horizontal texture detector 145 comprises a texture detector 150, a horizontal texture multiplexer 152, an adder 154 and a horizontal texture counter 156. The gray level comparator 132 generates gray level differences between horizontal neighboring pixels in an image unit. The texture detector 150 receives the gray level differences between horizontal neighboring pixels and compares them to a horizontal gray level reference value. The texture detector 150 changes the value of a horizontal block variable according to the comparison results. The image unit is the horizontal texture block if the horizontal block variable exceeds a horizontal block reference value. The texture detector 150 generates a horizontal texture detection signal H_texture according to whether the image block is a horizontal texture block. When receiving the horizontal texture detection signal H_texture, the horizontal texture multiplexer 152 outputs 1 when the horizontal texture detection signal H_texture indicates that the image block is a horizontal texture block. Otherwise, the horizontal texture multiplexer 152 outputs −1 to the adder 154. The adder 154 then sums the value of the horizontal texture counter 156 and the output of the horizontal texture multiplexer 152 to output to the horizontal texture counter 156, updating the value of the horizontal texture counter 156. The value of the horizontal texture counter 156 then outputs the value thereof to the multiplier 147 to adjust the total gray level increment output from the multiplexer 144. The vertical texture detector 146 is similar to the horizontal textured detector 145 shown in FIG. 15 as is known to those skilled in the art.

The sum of the total gray level increment adjusted by the horizontal textured detector 145 and the vertical textured detector 146 and gray level of the current pixel is used as a sharpness gray level of the current pixel to be output as an sharpness enhanced image.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image sharpness method comprising:
determining a plurality of sharpness gray level increments for a current pixel in accordance with a non-linear visual function and gray level differences between the current pixel and the neighboring pixels of the current pixel;
using the sum of the sharpness gray level increments as a total sharpness gray level increment; and
using the sum of the total sharpness gray level increment and the gray level of the current pixel as a sharpness gray level of the current pixel.

2. The image sharpness method as claimed in claim 1, wherein the step of determination further comprises using a predetermined increment as the sharpness gray level increments corresponding to the gray level differences between the current pixel and the first pixel and that between the current pixel and the second pixel when a gray level difference between a first pixel and a second pixel is less than a reference value, wherein the first and second pixels are the neighboring pixels of the current pixel and the current pixel is between the first and second pixels.

3. The image sharpness method as claimed in claim 2, wherein the predetermined increment is zero.

4. The image sharpness method as claimed in claim 2, further comprising determining whether an image unit including the current pixel is a horizontal texture block in accordance with the gray level differences between each horizontal neighboring pixel of the image unit.

5. The image sharpness method as claimed in claim 4, wherein the step of determining whether an image unit is a horizontal texture block further comprises:
comparing the gray level differences between each horizontal neighboring pixel of the image unit to a horizontal gray level difference reference value; and
changing a value of a horizontal block variable according to the comparison result wherein if the horizontal block variable exceeds a horizontal block reference value, the image unit is the horizontal texture block.

6. The image sharpness method as claimed in claim 4, further comprising changing a value of a horizontal texture variable in accordance with the result of whether the image unit is the horizontal texture block and adjusting the total sharpness gray level increment in accordance with the horizontal texture variable and a horizontal texture threshold.

7. The image sharpness method as claimed in claim 2, further comprising determining whether an image unit including the current pixel is a vertical texture block in accordance with the gray level differences between each vertical neighboring pixel of the image unit.

8. The image sharpness method as claimed in claim 7, wherein the step of determining whether an image unit is a vertical texture block further comprises:
comparing the gray level differences between each vertical 1 neighboring pixel of the image unit to a vertical gray level difference reference value; and
changing a value of a vertical block variable according to the comparison result wherein if the vertical 1 block variable exceeds a vertical block reference value, the image unit is the vertical texture block.

9. The image sharpness method as claimed in claim 1, further comprising determining whether an image unit including the current pixel is a horizontal texture block in accordance with the gray level differences between each horizontal neighboring pixel of the image unit.

10. The image sharpness method as claimed in claim 9, wherein the step of determining whether an image unit is a horizontal texture block further comprises:
comparing the gray level differences between each horizontal neighboring pixel of the image unit to a horizontal gray level difference reference value; and
changing a value of a horizontal block variable according to the comparison result wherein if the horizontal block variable exceeds a horizontal block reference value, the image unit is the horizontal texture block.

11. The image sharpness method as claimed in claim 9, further comprising changing a value of a horizontal texture variable in accordance with the result of whether the image unit is the horizontal texture block and adjusting the total sharpness gray level increment in accordance with the horizontal texture variable and a horizontal texture threshold.

12. The image sharpness method as claimed in claim 9, wherein the image unit is a 3×3 pixel image unit.

13. The image sharpness method as claimed in claim 1, further comprising determining whether an image unit including the current pixel is a vertical texture block in accordance with the gray level differences between each vertical neighboring pixel of the image unit.

14. The image sharpness method as claimed in claim 13, wherein the step of determining whether an image unit is a vertical texture block further comprises:
comparing the gray level differences between each vertical 1 neighboring pixel of the image unit to a vertical gray level difference reference value; and
changing a value of a vertical block variable according to the comparison result wherein if the vertical 1 block variable exceeds a vertical block reference value, the image unit is the vertical texture block.

15. The image sharpness method as claimed in claim 13, further comprising changing a value of a vertical texture variable in accordance with the result of whether the image unit is the vertical texture block and adjusting the total sharpness gray level increment in accordance with the vertical texture variable and a vertical texture threshold.

16. An image sharpness method comprising:
determining a plurality of sharpness gray level increments for a current pixel in accordance with a non-linear visual function and gray level differences between the current pixel and the neighboring pixels of the current pixel, wherein when a gray level difference between a first pixel and a second pixel is less than a reference value, a predetermined increment is used as the sharpness gray level increments corresponding to the gray level differences between the current pixel and the first pixel and that between the current pixel and the second pixel, wherein the first and second pixels are the neighboring pixels of the current pixel and the current pixel is between the first and second pixels;
using the sum of the sharpness gray level increments as a total sharpness gray level increment;
determining whether an image unit including the current pixel is a horizontal texture block in accordance with the gray level differences between each horizontal neighboring pixel of the image unit;
changing a value of a horizontal texture variable in accordance with the result of whether the image unit is the horizontal texture block and adjusting the total sharpness gray level increment in accordance with the horizontal texture variable and a horizontal texture threshold; and
using the sum of the total sharpness gray level increment and the gray level of the current pixel as a sharpness gray level of the current pixel.

17. The image sharpness method as claimed in claim 16, wherein the predetermined increment is zero.

18. The image sharpness method as claimed in claim 16, wherein the step of determining whether an image unit is a horizontal texture block further comprises:
comparing the gray level differences between each horizontal neighboring pixel of the image unit to a horizontal gray level difference reference value; and
changing a value of a horizontal block variable according to the comparison result wherein if the horizontal block variable exceeds a horizontal block reference value, the image unit is the horizontal texture block.

19. The power management method as claimed in claim 16, wherein the image unit is a 3×3 pixel image unit.

20. The image sharpness method as claimed in claim 16, further comprising determining whether an image unit including the current pixel is a vertical texture block in accordance with the gray level differences between each vertical neighboring pixel of the image unit.

21. The image sharpness method as claimed in claim 20, wherein the step of determining whether an image unit is a vertical texture block further comprises:
comparing the gray level differences between each vertical 1 neighboring pixel of the image unit to a vertical gray level difference reference value; and
changing a value of a vertical block variable according to the comparison result wherein if the vertical 1 block variable exceeds a vertical block reference value, the image unit is the vertical texture block.

22. The image sharpness method as claimed in claim 20, further comprising changing a value of a vertical texture variable in accordance with the result of whether the image unit is the vertical texture block and adjusting the total sharpness gray level increment in accordance with the vertical texture variable and a vertical texture threshold.

23. An image sharpness device comprising:
a pixel gray level comparator receiving an image data and comparing the gray level of a current pixel of the image data to that of the neighboring pixels of the current pixel to generate a plurality of gray level differences; and
a sharpness processor coupled to the pixel gray level comparator, determining a plurality of sharpness gray level increments in accordance with each gray level difference and a non-linear visual function, using the sum of the sharpness gray level increments as a total sharpness gray level increment and using the sum of the total sharpness gray level increment and the gray level of the current pixel as a sharpness gray level of the current pixel.

24. The image sharpness device as claimed in claim 23, wherein the sharpness processor compares the gray level between a first pixel and a second pixel wherein when the gray level difference between the first pixel and the second pixel is less than a reference value, the sharpness gray level increments corresponding to the gray level differences between the current pixel and the first pixel and that between the current pixel and the second pixel are a predetermined increment, wherein the first and second pixels are the neighboring pixels of the current pixel and the current pixel is between the first and second pixels.

25. The image sharpness device as claimed in claim 24, wherein the predetermined increment is zero.

26. The image sharpness device as claimed in claim 23, wherein the pixel gray level comparator compares the gray level of each horizontal neighboring pixel of an image unit including the current pixel and determines whether the image unit including the current pixel is a horizontal texture block according to the comparison result.

27. The image sharpness device as claimed in claim 26, wherein the pixel gray level comparator compares the gray level differences between each horizontal neighboring pixel of the image unit to a horizontal gray level difference reference value and changes a value of a horizontal block variable according to the comparison result wherein if the horizontal block variable exceeds a horizontal block reference value, the image unit is the horizontal texture block.

28. The image sharpness device as claimed in claim 26, wherein the sharpness processor changes a value of a horizontal texture variable in accordance with the result of whether the image unit is the horizontal texture block and adjusts the total sharpness gray level increment in accordance with the horizontal texture variable and a horizontal texture threshold.

29. The image sharpness device as claimed in claim 23, wherein the pixel gray level comparator compares the gray level of each vertical neighboring pixel of an image unit including the current pixel and determines whether the image unit including the current pixel is a vertical texture block according to the comparison result.

30. The image sharpness device as claimed in claim 29, wherein the pixel gray level comparator compares the gray level differences between each vertical neighboring pixel of the image unit to a vertical gray level difference reference value and changes a value of a vertical block variable according to the comparison result wherein if the vertical block variable exceeds a vertical block reference value, the image unit is the vertical texture block.

31. The image sharpness device as claimed in claim 29, wherein the sharpness processor changes a value of a vertical texture variable in accordance with the result of whether the image unit is the vertical texture block and adjusts the total sharpness gray level increment in accordance with the vertical texture variable and a vertical texture threshold.
